(19) United States
(12) Patent Application Publication
(10) Pub. No.: US 2025/0346769 A1
(43) Pub. Date: Nov. 13, 2025

(54) MULTILAYER COMPOSITE INTUMESCENT FIRE-RETARDANT COATING MATERIAL, PREPARATION METHOD THEREFOR, AND METHOD OF USING THE SAME

(71) Applicants: STATE GRID SHANDONG ELECTRIC POWER RESEARCH INSTITUTE, Jinan (CN); STATE GRID CORPORATION OF CHINA, Beijing (CN)

(72) Inventors: Xiaoming WANG, Jinan (CN); Xingeng LI, Jinan (CN); Gengzeng ZHU, Jinan (CN); Lipeng ZHANG, Jinan (CN); Wenjing LI, Jinan (CN); Fengjie YAN, Jinan (CN); Shuo YAO, Jinan (CN); Zhiyue GAO, Jinan (CN); Baoshuai DU, Jinan (CN); Zhibin FAN, Jinan (CN); Zhenyue ZHANG, Jinan (CN); Lijun ZONG, Jinan (CN); Yaping WU, Jinan (CN); Qian WANG, Jinan (CN); Hui TIAN, Jinan (CN); Die WANG, Jinan (CN); Chunxu MI, Jinan (CN); Weina WANG, Jinan (CN)

(21) Appl. No.: 19/007,098

(22) Filed: Dec. 31, 2024

Related U.S. Application Data
(63) Continuation of application No. PCT/CN2024/135758, filed on Nov. 29, 2024.

(30) Foreign Application Priority Data
May 10, 2024 (CN) 202410573156.2

(51) Int. Cl. C09D 5/18; C09D 7/40; C09D 7/61; C09D 7/80; C09D 163/00

(52) U.S. Cl. CPC C09D 5/185; C09D 7/61; C09D 7/70; C09D 7/80; C09D 163/00

(57) ABSTRACT

Disclosed are a multilayer composite intumescent fire-retardant coating material, a preparation method therefor, and a method of using the same, relating to the technical field of intumescent fire-retardant coating materials. The coating material comprises a bottom fire-retardant coating material and a surface fire-retardant coating material, and a composite method is a single layer or presents an ABAB . . . type. The bottom fire-retardant coating material contains a physical expansive agent. The surface fire-retardant coating material contains a gas-foaming expansive agent. By fully utilizing the filling effect of the physical expansive agent and the expanding effect of the gas-foaming expansive agent, the size of pores formed in the expansion layer under the fire is substantially reduced, which not only improves the compactness and strength of the expansion layer but also improves the thermal insulation performance of the expansion layer.

### CROSS-REFERENCES TO RELATED APPLICATIONS

This is a continuation of International Patent Application No. PCT/CN2024/135758, filed on Nov. 29, 2024, which claims priority to Chinese Patent Application No. 202410573156.2 filed with the China National Intellectual Property Administration on May 10, 2024, the disclosure of which is incorporated herein by reference in its entirety.

### TECHNICAL FIELD

The present application relates to the technical field of intumescent fire-retardant coating materials, and in particular relates to a multilayer composite intumescent fire-retardant coating material, a preparation method therefor, and a method of using the same.

### BACKGROUND

The existing intumescent fire-retardant coating material has the problem of poor thermal insulation of expansion layer, and the addition of non-foaming expansive agent to fire-retardant coating material is one of the ways to improve the quality of the expansion layer of epoxy fire-retardant coating material. Expanded graphite is the most commonly added material, the worm-like graphite after expanding is filled in the expansion layer to avoid the formation of large pores and weaken the thermal transmission of the expansion layer thermal convection, and the resulting expansion layer generally have a high strength; however, the graphite with a high thermal conductivity coefficient in such expansion layer improves the overall thermal conductivity coefficient, and the open pores are often formed in such expansion layer, which weaken the thermal insulation to a certain degree. The effect of improving the fireproof performance of coating materials by using expanded graphite is limited. In some studies, the combination of fire-retardant coatings is used in the coating, for example, the epoxy fire-retardant coating material and acrylic fire-retardant coating material are combined to obtain the coating, but its fireproof performance is not improved; the fire-retardant coating prepared by combining the aluminum foil with the fire-retardant coating material under fire shows a reduced temperature rise rate of the basic material but the final temperature is not improved. Patent ZL202210867325.4 provides a solution of compounding the intumescent fire-retardant coating with non-intumescent closed coating, in which the bottom intumescent fire-retardant coating system is mainly used to ensure the thermal insulation performance of the coating, and the surface heat-resistant compact closed layer is used to block the combustion of the coating, but it does not solve the problem of weak fireproof performance of the coating caused by the large-size pores in the base of the epoxy fire-retardant coating material.

In view of the problem that the expansion layer has poor thermal insulation performance due to the existence of large-size pores easily caused by the inherent large high-temperature viscosity and strong compactness of the epoxy resin intumescent fire-retardant coating material, it is necessary to develop an epoxy intumescent fire-retardant coating material with high compactness after expansion.

### SUMMARY

The following is a brief summary of subject matter that is described in detail herein. This summary is not intended to be limiting as to the scope of the claims.

In order to solve the above technical problems, the present application discloses a multilayer composite intumescent fire-retardant coating material, a preparation method therefor, and a method of using the same. The full-filling characteristic of the bottom fire-retardant coating material and the excellent expansion performance of the surface fire-retardant coating material are used to avoid the problem of the poor adhesion between the expansion layer and the basic material caused by bottom large pores of the expansion layer at the high expansion rate, and the epoxy intumescent fire-retardant coating material has both a high strength and a high expansion rate, and achieves excellent fireproof performance.

In order to realize the above objects, the present application adopts the following technical solutions.

In a first aspect, the present application provides a multilayer composite intumescent fire-retardant coating material.

In an optional embodiment, the multilayer composite intumescent fire-retardant coating material comprises a bottom fire-retardant coating material containing a physical expansive agent and a surface fire-retardant coating material containing a gas-foaming expansive agent.

Optionally, a composite method of the bottom fire-retardant coating material and the surface fire-retardant coating material is a single layer or presents an ABAB . . . type, wherein the single-layer composite method is one layer of bottom fire-retardant coating material-surface fire-retardant coating material, and the type of ABAB . . . refers to bottom fire-retardant coating material-surface fire-retardant coating material/bottom fire-retardant coating material-surface fire-retardant coating material/bottom fire-retardant coating material-surface fire-retardant coating material.

Optionally, the bottom fire-retardant coating material comprises component A and component B, wherein the component A is composed of the following raw materials in parts by weight:

| | | |
|---|---|---|
| binder | 20-60 | parts; and |
| acid catalyst | 1-40 | parts; |

the component B is composed of the following raw materials in parts by weight:

| | | |
|---|---|---|
| curing agent | 5-35 | parts; and |
| physical expansive agent | 0.2-20 | parts. |

The physical expansive agent refers to an inorganic substance and a modified substance which expands at high temperature and is not decomposed by high temperature. Preferably, the physical expansive agent is at least one of expanded graphite, vermiculite, perlite, pitchstone, and obsidian, preferably expanded graphite.

The epoxy resin binder may comprise one or more of epoxy resins such as commonly used E22, E44, E51, and a mixture thereof such as E44/E51, E22/E51, or E22/E44, etc. The epoxy resin binder may comprise a commercially available epoxy resin or a modified epoxy resin, such as bisphenol A, bisphenol F, phenolic modified epoxy resin, or organosilicon modified epoxy resin. When the solid resin such as E22 is selected as the epoxy resin binder, it can be dissolved by a reactive active diluent and converted to liquid to serve as a resin binder of the bottom fire-retardant coating material. A low-molecular-mass resin can be also used to compound with the solid resin and give a liquid state, to serve as a resin binder.

The acid catalyst mainly refers to a substance that generates an acid in thermal decomposition and promotes the polymers in dehydration and carbon formation, and polyphosphoric acid is preferred, and in particular, a phosphoric acid catalyst containing N element is preferred. A suitable catalyst known to those skilled in the art comprises ammonium polyphosphate, ammonium polyphosphate, or melamine pyrophosphate, etc., and a phosphate salt that is modified or coated to improve durable performance such as water resistance. The acid catalyst also comprises boric acid and a borate substance such as boric acid, zinc borate, or ammonium pentaborate, etc.

The curing agent is mainly an amine curing agent which can be cured at room temperature, comprising one or more of aromatic amine, alicyclic amine, and imide, and a modified amine curing agent thereof.

Optionally, the component A and component B of the bottom fire-retardant coating material further comprise an expansion-layer reinforcing agent.

Based on different strength of the expansion layer, an expansion-layer reinforcing agent can also be added. The expansion-layer reinforcing agent comprises a surface ceramicized material or a fibrous material. The ceramicized reinforcing material comprises a low-melting-point glass, silicon oxide, kaolin, silicate, and natural minerals such as wollastonite, whetstone, basalt, etc., and is in the form of granule or lamellae. The fibrous material comprises an organic fiber, a carbon fiber, a glass fiber, a mineral fiber, a manmade inorganic fiber, with a length ranging from a few microns to thousands of microns.

Optionally, the bottom fire-retardant coating material comprises component A and component B,
wherein the component A is composed of the following raw materials in parts by weight:

| | | |
|---|---|---|
| binder | 20-60 | parts; |
| acid catalyst | 1-40 | parts; and |
| expansion-layer reinforcing agent | 0-20 | parts; |

the component B is composed of the following raw materials in parts by weight:

| | | |
|---|---|---|
| curing agent | 5-35 | parts; |
| physical expansive agent | 0.2-20 | parts; and |
| expansion-layer reinforcing agent | 0-20 | parts. |

(

Optionally, the surface fire-retardant coating material comprises a first component and a second component, wherein the first component is composed of the following raw materials in parts by weight:

| | | |
|---|---|---|
| binder | 20-60 | parts; and |
| acid catalyst | 1-40 | parts; |

the second component is composed of the following raw materials in parts by weight:

| | | |
|---|---|---|
| curing agent | 5-35 | parts; and |
| gas-foaming expansive agent | 1-20 | parts. |

The gas-foaming expansive agent plays a major role. The gas-foaming expansive agent refers to a material which expands the coating by releasing a non-flammable and flame-retardant gas at high temperature, comprising one or more of a nitrogen-containing compound, a nitrogen-containing polymer, a nitrogen-containing derivative, or a nitrogen-coated material, such as melamine, a melamine salt, urea, guanidine, and a derivative or a mixture thereof, preferably melamine; or comprising a compound capable of releasing water and flame-retardant gas carbon dioxide, such as magnesium hydroxide, aluminum hydroxide, a carbonate salt; or comprising a natural mineral such as talc, magnesite, dolomite, etc.

Optionally, the first component and the second component of the surface fire-retardant coating material further comprise an expansion-layer reinforcing agent.

Optionally, the surface fire-retardant coating material comprises the first component and the second component, wherein the first component is composed of the following raw materials in parts by weight:

| | | |
|---|---|---|
| binder | 20-60 | parts; |
| acid catalyst | 1-40 | parts; and |
| expansion-layer reinforcing agent | 0-20 | parts; |

the second component is composed of the following raw materials in parts by weight:

| | | |
|---|---|---|
| curing agent | 5-35 | parts; |
| gas-foaming expansive agent | 1-20 | parts; and |
| expansion-layer reinforcing agent | 0-20 | parts. |

The epoxy resin binder, the acid catalyst, the curing agent, and the expansion-layer reinforcing agent are the same as in the bottom fire-retardant coating material.

In a second aspect, the present application provides a preparation method for the multilayer composite intumescent fire-retardant coating material.

In an optional embodiment, the preparation method for the multilayer composite intumescent fire-retardant coating material comprises the following steps:
preparing the bottom fire-retardant coating material; and
preparing the surface fire-retardant coating material.

Optionally, the step of preparing the bottom fire-retardant coating material specifically comprises:
adding a rheological agent, a plasticizer, and other additives to an epoxy resin binder in sequence, and stirring at a speed of 400-1000 rpm for 1-20 min;
adding an acid catalyst and stirring at 2000-4000 rpm for 10-40 min;
if necessary, adding an expansion-layer reinforcing agent, and stirring at 2000-4000 rpm for 10-40 min to obtain component A;
adding a physical expansive agent to a curing agent, and stirring at 100-4000 rpm for 1-20 min;
if necessary, adding an expansion-layer reinforcing agent, and stirring at 1000-4000 rpm for 10-40 min to obtain component B; and
mixing the component A and the component B evenly to obtain the bottom fire-retardant coating material.

Optionally, the step of preparing the surface fire-retardant coating material specifically comprises:
adding a rheological agent, a plasticizer, and other additives to an epoxy resin binder in sequence, and stirring at a speed of 400-1000 rpm for 1-20 min;
adding an acid catalyst and stirring at 2000-4000 rpm for 10-40 min;
if necessary, adding an expansion-layer reinforcing agent, and stirring at 2000-4000 rpm for 10-40 min to obtain a first component;
adding a gas-foaming expansive agent to a curing agent, and stirring at 100-4000 rpm for 1-20min;
adding an expansion-layer reinforcing agent, and stirring at 1000-4000 rpm for 10-40 min to obtain a second component; and
mixing the first component and the second component evenly to obtain the surface fire-retardant coating material.

In a third aspect, the present application provides an application of the multilayer composite intumescent fire-retardant coating material.

In an optional embodiment, the multilayer composite intumescent fire-retardant coating material is applied to fireproofing of a structure or a component made of steel, concrete, and wood.

In a fourth aspect, the present application provides a fireproof treatment method for a basic material, which comprises the following steps:
S1. pretreating a surface of the basic material;
S2. stirring the bottom fire-retardant coating material of the fire-retardant coating material according to the first aspect at 400-4000 rpm and coating on the surface of the basic material to reach a desired thickness; and
S3. stirring the surface fire-retardant coating material of the fire-retardant coating material according to the first aspect at 400-4000 rpm, and coating the surface fire-retardant coating material on a gelled bottom fire-retardant coating material to reach a desired thickness.

In step S1, the surface pretreatment of the basic material comprises: removing rust, dust and other adherents from the surface of the basic material, and cleaning the surface with ethanol or treating the surface with sandblasting/shot peening to a 2.5 Ra level, wherein the process is required to be completed within 8 h.

The coating method comprises spraying, brushing, rolling, or troweling, etc.

Optionally, the bottom fire-retardant coating material and the surface fire-retardant coating material are stacked alternately for a plurality of times to present ABAB . . . coatings.

Optionally, an anti-aging layer coating material is coated on the surface of the surface fire-retardant coating material, and the surface anti-aging layer coating material is selected according to the overall aging resistance and compatibility with the surface fire-retardant coating material, and controlled to have a thickness of 20-50 μm.

If the thickness of the coating is too thick, a metal wire mesh, an organic wire mesh or an inorganic wire mesh may be added during a plurality of construction processes in the coating construction process, that is, a wire mesh is added inside the coating material so as to improve the construction quality of the coating material and enhance the strength of the coating after the coating material is cured.

The beneficial effect of the present application is that by combining the bottom fire-retardant coating material containing a physical expansive agent and the surface fire-retardant coating material containing a gas-foaming expansive agent, a multilayer composite fire-retardant coating material system is formed. By fully utilizing the filling effect of the physical expansive agent and the expanding effect of the gas-foaming expansive agent, the size of pores formed in the expansion layer under the fire is substantially reduced, which not only improves the compactness and strength of the expansion layer but also improves the thermal insulation performance of the expansion layer. Thermal transfer to the protected material through the expansion layer is slowed down, delaying the failure time of the protected material, and enhancing the whole fireproof performance of the fire-retardant coating material.

Other aspects can be understood after the accompanying drawings and the detailed description are read and understood.

### BRIEF DESCRIPTION OF DRAWINGS

The accompanying drawings are used to provide a further understanding of the technical solutions herein, form a part of the specification, explain the technical solutions herein in conjunction with the embodiments of the present application, and do not constitute a limitation of the technical solutions herein.

FIG. 1 shows a cross-sectional view of the expansion layer of the coating prepared in Example 1 of the present application;

FIG. 2 shows a cross-sectional view of the expansion layer of the coating prepared in Example 2 of the present application;

FIG. 3 shows a cross-sectional view of the expansion layer of the coating prepared in Example 3 of the present application;

FIG. 4 shows a cross-sectional view of the expansion layer of the coating prepared in Comparative Example 1 of the present application;

FIG. 5 shows a cross-sectional view of the expansion layer of the coating prepared in Comparative Example 2 of the present application;

FIG. 6 shows a cross-sectional view of the expansion layer of the coating prepared in Comparative Example 3 of the present application;

FIG. 7 shows a back temperature curve of the coating under flame prepared in Example 1 of the present application;

FIG. 8 shows a back temperature curve of the coating under flame prepared in Example 2 of the present application;

FIG. 9 shows a back temperature curve of the coating under flame prepared in Example 3 of the present application;

FIG. 10 shows a back temperature rise curve of the coating under flame prepared in Comparative Example 1 of the present application;

FIG. 11 shows a back temperature rise curve of the coating under flame prepared in Comparative Example 2 of the present application;

FIG. 12 shows a back temperature rise curve of the coating under flame prepared in Comparative Example 3 of the present application.

### DETAILED DESCRIPTION

The technical solutions in examples of the present application will be described clearly and completely in the following via the accompanying drawings in examples of the present application. Obviously, the described examples are only a part of the examples of the present application, and not all of the examples. Based on the examples of the present application, other examples obtained by those skilled in the art without creative efforts all fall within the protection scope of the present application.

### EXAMPLE 1

A multilayer composite intumescent fire-retardant coating material comprises a bottom fire-retardant coating material containing a physical expansive agent and a surface fire-retardant coating material containing a gas-foaming expansive agent.

### 1. Preparation of Bottom Fire-Retardant Coating Material

### (1) Component A Preparation

48.07 g of E51 epoxy resin was taken and added with 18.76 g of ammonium polyphosphate, and stirred with a high-speed disperser at a speed of 2000 rpm for 15 min;

1.43 g of basalt fiber was added to the above mixture, and stirred with a high-speed disperser at a speed of 3000 rpm for 10 min to prepare the component A;

### (2) Component B Preparation

19.93 g of polyamide curing agent was taken and added with 11.53 g of expanded graphite, and stirred with a high-speed disperser at a speed of 1000 rpm for 10 min;

1.54 g of basalt fiber was added to the above mixture, and stirred with a high-speed disperser at a speed of 1000 rpm for 10 min to prepare the component B.

### 2. Preparation of Surface Fire-Retardant Coating Material

(1) First Component Preparation 38.61 g of E51 epoxy resin was taken and added with 14.39 g of ammonium polyphosphate, and stirred with a high-speed disperser at a speed of 2000 rpm for 15 min;

15.23 g of calcium silicate was added to the above mixture, and stirred with a high-speed disperser at a speed of 2000 rpm for 20 min to prepare the first component;

### (2) Second Component Preparation

15.34 g of polyamide curing agent was taken and added with 12.3 g of melamine, and stirred with a high-speed disperser at a speed of 1000 rpm for 10 min;

3.32 g of basalt fiber was added to the above mixture, and stirred with a high-speed disperser at a speed of 3000 rpm for 10 min to prepare the second component.

### Coating Material Application

The basic material of steel plate was cleaned with ethanol to remove the surface oil, and a size of the steel plate was 150×100×3 mm.

The component A and component B of the bottom fire-retardant coating material were mixed according to a mass ratio of 1:1, and stirred evenly with mechanical stirring at a speed of 400 rpm, and the coating material was coated on the steel plate basic material with a blade; the bottom fire-retardant coating material had a coating thickness of about 1.5 mm.

When gel was observed in the bottom fire-retardant coating material, that is, the bottom fire-retardant coating material was cured without sagging, the first component and the second component of the surface fire-retardant coating material were mixed at a mass ratio of 1:1, and then stirred evenly with mechanical stirring at a speed of 400 rpm, the coating material was coated on the bottom fire-retardant coating with a blade, and the surface fire-retardant coating material had a coating thickness of about 1.5 mm.

The overall average thickness of the coating structure in Example 1 was 3.21 mm. The target thickness was 3 mm, but during the coating practice, the coating thickness could not be precisely controlled and usually had deviation.

### EXAMPLE 2

The preparation method of the coating material is the same as that of Example 1.

In the aspect of coating material application, the method of Example 2 was the same as that of Example 1. During the application, about 0.75 mm of the bottom fire-retardant coating material was coated on the steel plate, and then about 0.75 mm of the surface fire-retardant coating material was coated, and then about 0.75 mm of the bottom fire-retardant coating material was coated and finally about 0.75 mm of the surface fire-retardant coating material was coated.

The overall average thickness of the coating structure in Example 2 was 3.34 mm.

### EXAMPLE 3

A multilayer composite intumescent fire-retardant coating material comprises a bottom fire-retardant coating material containing a physical expansive agent and a surface fire-retardant coating material containing a gas-foaming expansive agent.

### 1. Preparation of Bottom Fire-Retardant Coating Material

### (1) Component A Preparation

48.13 g of E51 epoxy resin was taken and added with 16.93 g of ammonium polyphosphate, and stirred with a high-speed disperser at a speed of 2000 rpm for 15 min;

1.33 g of basalt fiber was added to the above mixture, and stirred with a high-speed disperser at a speed of 3000 rpm for 10 min to prepare the component A;

### (2) Component B Preparation

20.02 g of polyamide curing agent was taken, added with 14.02 g of expanded graphite, and stirred with a high-speed disperser at a speed of 1000 rpm for 10 min;

0.94 g of basalt fiber was added to the above mixture, and stirred with a high-speed disperser at a speed of 1000 rpm for 10 min to prepare the component B.

### 2. Preparation of Surface Fire-Retardant Coating Material

### (1) First Component Preparation

38.28 g of E51 epoxy resin was taken and added with 14.56 g of ammonium polyphosphate, and stirred with a high-speed disperser at a speed of 2000 rpm for 15 min;

13.13 g of calcium silicate was added to the above mixture, and stirred with a high-speed disperser at a speed of 2000 rpm for 20 min to prepare the first component;

### (2) Second Component Preparation

15.69 g of polyamide curing agent was taken, added with 15.61 g of melamine, and stirred with a high-speed disperser at a speed of 1000 rpm for 10 min;

2.55 g of basalt fiber was added to the above mixture, and stirred with a high-speed disperser at a speed of 3000 rpm for 10 min to prepare the second component.

### Coating Material Application

The application of Example 3 was the same as the application of Example 2. The overall average thickness of the coating structure in Example 3 was 3.42 mm.

### Comparative Example 1

### Coating Material Preparation

### (1) Component A Preparation

48.23 g of E51 epoxy resin was taken, added with 19.01 g of ammonium polyphosphate, and stirred with a high-speed disperser at a speed of 2000 rpm for 15 min;

1.46 g of basalt fiber was added to the above mixture, and stirred with a high-speed disperser at a speed of 3000 rpm for 10 min to prepare the component A;

### (2) Component B Preparation

19.98 g of polyamide curing agent was taken, added with 11.48 g of expanded graphite, and stirred with a high-speed disperser at a speed of 1000 rpm for 10 min;

1.58 g of basalt fiber was added to the above mixture, and stirred with a high-speed disperser at a speed of 1000 rpm for 10 min to prepare the component B.

### Coating Material Application

The basic material of steel plate was cleaned with ethanol to remove the surface oil, and a size of the steel plate was 150×100×3 mm.

The component A and component B of the above fire-retardant coating material were mixed, and stirred evenly with mechanical stirring at a speed of 400 rpm, and the coating material was coated on the steel plate basic material with a blade; the fire-retardant coating material had a coating thickness of about 3 mm.

The overall average thickness of the coating structure in Comparative Example 1 was 3.29 mm.

### Comparative Example 2

### Coating Material Preparation

### (1) Component A Preparation

38.43 g of E51 epoxy resin was taken and added with 14.46 g of ammonium polyphosphate, and stirred with a high-speed disperser at a speed of 2000 rpm for 15 min;

15.19 g of calcium silicate was added to the above mixture, and stirred with a high-speed disperser at a speed of 2000 rpm for 20 min to prepare the component A;

### (2) Component B Preparation

15.41 g of polyamide curing agent was taken, added with 12.25 g of melamine, and stirred with a high-speed disperser at a speed of 1000 rpm for 10 min;

3.41 g of basalt fiber was added to the above mixture, and stirred with a high-speed disperser at a speed of 3000 rpm for 10 min to prepare the component B.

### Coating Material Application

The basic material of steel plate was cleaned with ethanol to remove the surface oil, and a size of the steel plate was 150×100×3 mm.

The component A and component B of the above fire-retardant coating material were mixed, and stirred evenly with mechanical stirring at a speed of 400 rpm, and the coating material was coated on the steel plate basic material with a blade; the fire-retardant coating material had a coating thickness of about 3 mm.

The overall average thickness of the coating structure in Comparative Example 2 was 3.34 mm.

### Comparative Example 3

### Coating Material Preparation

### 1. Preparation of Bottom Coating Material

### (1) Component A Preparation

38.59 g of E51 epoxy resin was taken and added with 14.45 g of ammonium polyphosphate, and stirred with a high-speed disperser at a speed of 2000 rpm for 15 min;

15.27 g of calcium silicate was added to the above mixture, and stirred with a high-speed disperser at a speed of 2000 rpm for 20 min to prepare the component A;

### (2) Component B Preparation

15.38 g of polyamide curing agent was taken, added with 12.23 g of melamine, and stirred with a high-speed disperser at a speed of 1000 rpm for 10 min;

3.36 g of basalt fiber was added to the above mixture, and stirred with a high-speed disperser at a speed of 3000 rpm for 10 min to prepare the component B.

### 2. Preparation of Surface Coating Material

### (1) First Component Preparation

48.12 g of E51 epoxy resin was taken and added with 18.69 g of ammonium polyphosphate, and stirred with a high-speed disperser at a speed of 2000 rpm for 15 min;

1.47 g of basalt fiber was added to the above mixture, and stirred with a high-speed disperser at a speed of 3000 rpm for 10 min to prepare the first component;

### (2) Second Component Preparation

19.89 g of polyamide curing agent was taken, added with 11.58 g of expanded graphite, and stirred with a high-speed disperser at a speed of 1000 rpm for 10 min;

1.58 g of basalt fiber was added to the above mixture, and stirred with a high-speed disperser at a speed of 1000 rpm for 10 min to prepare the second component.

### Coating Material Application

The application process was the same as the application process of the Examples.

The overall average thickness of the coating structure in Comparative Example 3 was 3.27 mm.

### Performance Test of Coating Material

The fire resistance test for the coatings in the above examples and the comparative examples were the same, specifically: an alcohol blast burner was ignited, and the fire was directed vertically upwards. When the fire was stabilized, the sample with a cured coating was placed 90 mm above the blast burner port, the coating was facing the fire, and the back side of the sample directly above the fire was welded with a thermocouple to detect the back temperature of the sample. After the back temperature of the sample was stabilized, the fire was extinguished and the thickness of the expansion layer was detected. The thickness of the expansion layer was divided by 3 to obtain the expansion ratio of the coating.

Table 1 shows the expansion ratio and the maximum back temperature of the steel plate obtained by testing the above coating materials.

In examples and comparative examples, the A+B coating of Example 1 has a small expansion ratio, and the ABAB-type coatings of Example 2 and Example 3 have a high expansion ratio, and both maintain a low maximum back temperature. When the number of composite layers is increased, the expansion ratio of the coatings is increased, and the maximum back temperature is further reduced, indicating that the composite method of the present application has a better synergy effect. The coating of Comparative Example 1 is prepared from the consistent fire-retardant coating material of the bottom layer in examples, which has the smallest expansion ratio, and the highest maximum back temperature, and shows the worst fireproof performance. The coating of Comparative Example 2 is prepared from the consistent fire-retardant coating material of the surface layer in examples, which has a higher expansion ratio than that of Example 1 but a higher high back temperature than all examples, and the high expansion ratio of the surface layer does not provide superior fireproof performance. The coating of Comparative Example 3 is prepared by interchanging the bottom layer and the surface layer of examples, which has a slightly better expansion ratio than that of examples, and a substantially higher maximum back temperature than that of examples, and slightly poorer fireproof performance.

TABLE 1
Test results of coating material

| | | | | Comparative | Comparative | Comparative |
|---|---|---|---|---|---|---|
| Item | Example 1 | Example 2 | Example 3 | Example 1 | Example 2 | Example 3 |
| Maximum back | 253 | 243 | 235 | 292 | 258 | 269 |
| temperature | | | | | | |
| Expansion | 7.35 | 12.55 | 11.94 | 7.00 | 9.77 | 8.34 |
| ratio | | | | | | |

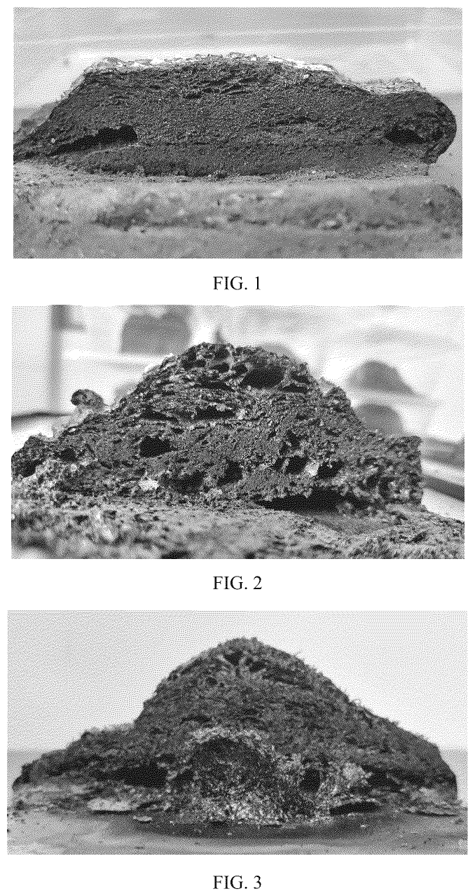

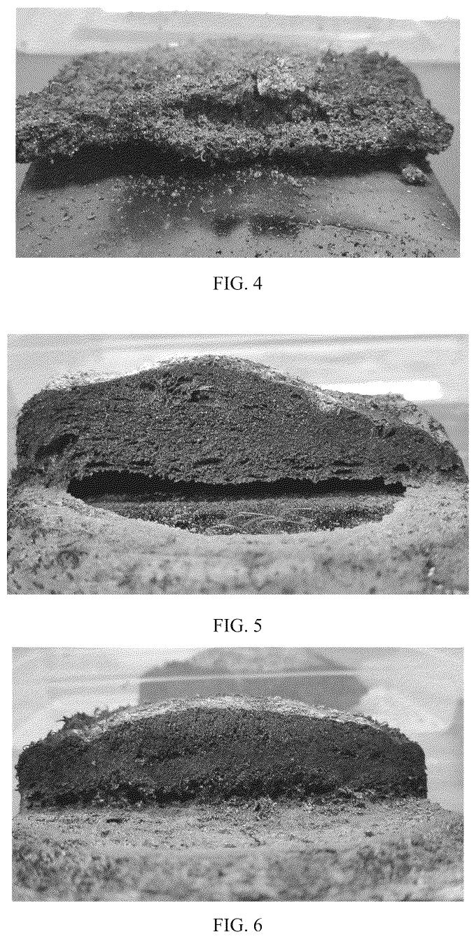

The cross sections of expansion layers formed under the fire of the samples are shown in FIGS. 1-6. The coating cross section of the expansion layer obtained in Example 1 of the present application shows a obvious expansion effect at the bottom coating and surface coating, wherein the expansion layer of the bottom coating is denser than the expansion layer of the coating in Comparative Example 1 where the expansion effect is mainly contributed by the physical expansive agent, and also has better adhesion with the basic material. In Example 2 and Example 3, the construction method of ABAB is adopted, and the thickness of each layer is thin, and the interlayer diffusion layer is more obvious during the construction process, which leads to an unclear interfacial boundary between the bottom layer and the surface layer after the expansion, but such composite method leads to an increase in the expansion ratio of the overall coating and a further reduction in the back temperature, providing an enhanced synergistic fireproof effect. Moreover, the expansion layer of the coating in all examples expands sufficiently, the pores inside the expansion layer are much smaller than the pores in the expansion layer in the comparative examples, and the adhesion between the expansion layer and the basic material of the examples is better than that of the expansion layer in the comparative examples.

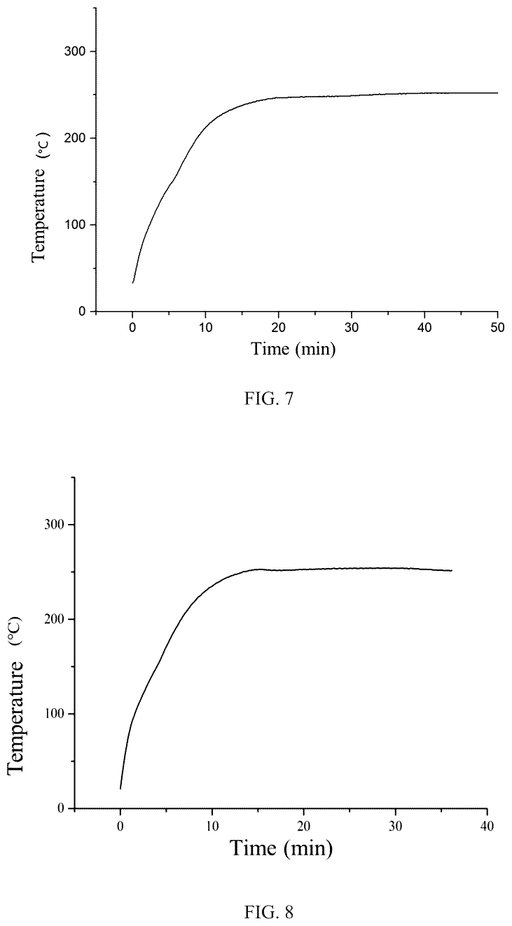

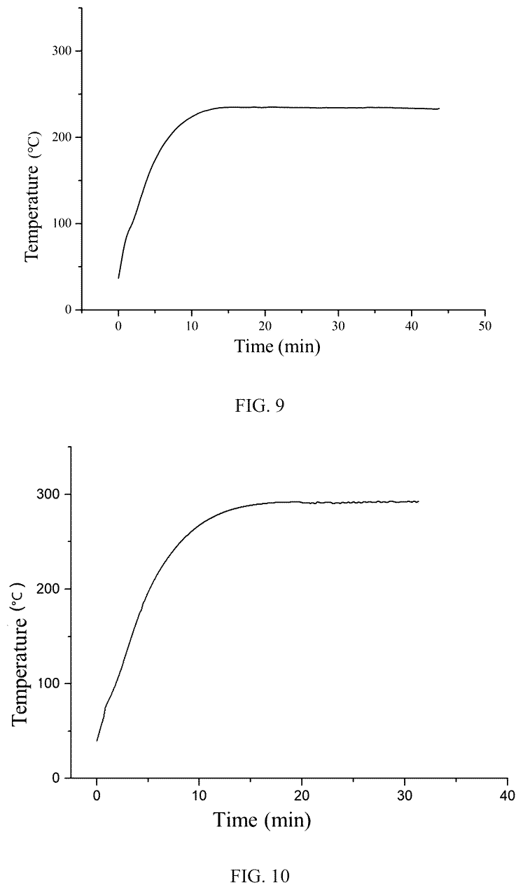

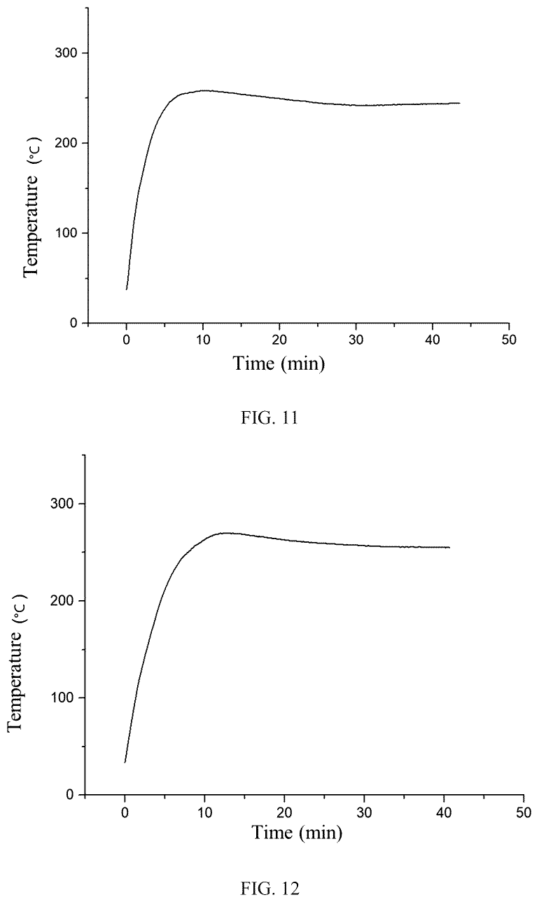

Corresponding to the above expansion layers, the temperature rise curves of the back temperature of the sample under fire are shown in FIGS. 7-12. The temperature rise curves of examples all show a relatively low back temperature and a relatively small temperature rise rate, and the temperature rise rate and the maximum back temperature in comparative examples are both relatively large. The reason is that when the coating material with a gas-foaming expansive agent as a main expansion component expands at high temperature, it is easy to expand and form small foaming structures near the fire. However, in the deep coating far from the fire, the gas expansion is more difficult, it is more likely to form large pores due to gathering, and large pores, on the contrary, provide a thermal convection condition, improve the temperature rise rate, and increase the back temperature, which is the reason why the fireproof performance of Comparative Example 2 is poor. When only physical expansive agent is used, the expansion layer formed by the coating material has a high thermal conductivity coefficient and cannot form a closed thermal insulation space, resulting in a high temperature rise rate and a high back temperature, which is the reason why the fireproof performance of Comparative Example 1 is poor. The surface coating material used in examples adopts a gas expansive agent, and the deep coating material adopts a physical expansive agent. Although the physical expansive agent such as expanded graphite has high thermal conductivity coefficient, it expands uniformly at high temperature to form a uniform expansion thermal insulation layer, which reduces the temperature rise rate and back temperature compared with the expansion layer with large pores. In Comparative Example 3, the coating material with a physical expansive agent and the coating material with a gas expansive agent are used oppositely, and their advantages are not used, resulting in poor fireproof performance.

Certainly, the above description is not a limitation of the present application, and the present application is not limited to the above examples. Any changes, adaptations, additions or substitutions made by those skilled in the art within the essential scope of the present application shall also fall within the protection of the present application.

1. A multilayer composite intumescent fire-retardant coating material, which comprises a bottom fire-retardant coating material containing a physical expansive agent and a surface fire-retardant coating material containing a gas-foaming expansive agent.

2. The multilayer composite intumescent fire-retardant coating material according to claim 1, wherein the bottom fire-retardant coating material comprises component A and component B,
wherein the component A comprises the following raw materials in parts by weight:

| | | |
|---|---|---|
| binder | 20-60 | parts; and |
| acid catalyst | 1-40 | parts; |

the component B comprises the following raw materials in parts by weight:

| | | |
|---|---|---|
| curing agent | 5-35 | parts; and |
| physical expansive agent | 0.2-20 | parts. |

3. The multilayer composite intumescent fire-retardant coating material according to claim 2, wherein the component A and the component B of the bottom fire-retardant coating material further comprise an expansion-layer reinforcing agent.

4. The multilayer composite intumescent fire-retardant coating material according to claim 3, wherein the bottom fire-retardant coating material comprises the component A and the component B,
wherein the component A is composed of the following raw materials in parts by weight:

| | | |
|---|---|---|
| binder | 20-60 | parts; |
| acid catalyst | 1-40 | parts; and |
| expansion-layer reinforcing agent | 0-20 | parts; |

the component B is composed of the following raw materials in parts by weight:

| | | |
|---|---|---|
| curing agent | 5-35 | parts; |
| physical expansive agent | 0.2-20 | parts; and |
| expansion-layer reinforcing agent | 0-20 | parts. |

5. The multilayer composite intumescent fire-retardant coating material according to claim 1, wherein the physical expansive agent is at least one of expanded graphite, vermiculite, perlite, pitchstone, and obsidian.

6. The multilayer composite intumescent fire-retardant coating material according to claim 1, wherein the surface fire-retardant coating material comprises a first component and a second component, wherein the first component comprises the following raw materials in parts by weight:

| | | |
|---|---|---|
| binder | 20-60 | parts; and |
| acid catalyst | 1-40 | parts; |

the second component comprises the following raw materials in parts by weight:

| | | |
|---|---|---|
| curing agent | 5-35 | parts; and |
| gas-foaming expansive agent | 1-20 | parts. |

7. The multilayer composite intumescent fire-retardant coating material according to claim 6, wherein the first component and the second component of the surface fire-retardant coating material further comprise an expansion-layer reinforcing agent.

8. The multilayer composite intumescent fire-retardant coating material according to claim 7, wherein the surface fire-retardant coating material comprises the first component and the second component, wherein the first component is composed of the following raw materials in parts by weight:

| | | |
|---|---|---|
| binder | 20-60 | parts; |
| acid catalyst | 1-40 | parts; and |
| expansion-layer reinforcing agent | 0-20 | parts; |

the second component is composed of the following raw materials in parts by weight:

| | | |
|---|---|---|
| curing agent | 5-35 | parts; |
| gas-foaming expansive agent | 1-20 | parts; and |
| expansion-layer reinforcing agent | 0-20 | parts. |

9. The multilayer composite intumescent fire-retardant coating material according to claim 1, wherein the gas-foaming expansive agent comprises one or more of a nitrogen-containing compound, a nitrogen-containing polymer, a nitrogen-containing derivative, or a nitrogen-coated material, or the gas-foaming expansive agent comprises a compound capable of releasing water and flame-retardant gas carbon dioxide, or the gas-foaming expansive agent comprises a natural mineral.

10. A preparation method for the fire-retardant coating material according to claim 1, which comprises the following steps:
preparing the bottom fire-retardant coating material; and
preparing the surface fire-retardant coating material.

11. The preparation method for the multilayer composite intumescent fire-retardant coating material according to claim 10, wherein the step of preparing the bottom fire-retardant coating material specifically comprises:
mixing components except a curing agent and a physical expansive agent according to proportions, and dispersing at a high speed to obtain component A;
adding the physical expansive agent to the curing agent, and dispersing at a high speed to obtain component B; and
mixing the component A and the component B evenly to obtain the bottom fire-retardant coating material.

12. The preparation method for the multilayer composite intumescent fire-retardant coating material according to claim 10, wherein the step of preparing the surface fire-retardant coating material specifically comprises:
mixing components except a curing agent and a gas-foaming expansive agent according to proportions, and dispersing at a high speed to obtain a first component;
adding the gas-foaming expansive agent to the curing agent, and dispersing at a high speed to obtain a second component; and
mixing the first component and the second component evenly to obtain the surface fire-retardant coating material.

13. A method of fireproofing a structure or a component made of steel, concrete, and wood, which comprises using the multilayer composite intumescent fire-retardant coating material according to claim 1.

14. A fireproof treatment method for a basic material, which comprises the following steps:
pretreating a surface of the basic material;
coating the bottom fire-retardant coating material of the fire-retardant coating material according to claim 1 on the surface of the basic material to reach a desired thickness; and
coating the surface fire-retardant coating material of the fire-retardant coating material according to claim 1 on a gelled bottom fire-retardant coating material to reach a desired thickness.

15. The fireproof treatment method according to claim 14, wherein the bottom fire-retardant coating material and the surface fire-retardant coating material are stacked alternately for a plurality of times to present ABAB . . . type coatings.

16. The fireproof treatment method according to claim 14, wherein an anti-aging layer coating material is coated on a surface of the surface fire-retardant coating material by a thickness of 20-50 μm.
